(19) United States
(12) Patent Application Publication
(10) Pub. No.: US 2019/0315337 A1
(43) Pub. Date: Oct. 17, 2019

(54) Control Method and Control Unit for a Drivetrain

(71) Applicant: ZF Friedrichshafen AG, Friedrichshafen (DE)

(72) Inventors: Anatol Weidenbach, Nonnenhorn (DE); Jens Kastens, Tettnang (DE); Matthias Arzner, Friedrichshafen (DE)

(21) Appl. No.: 16/384,190

(22) Filed: Apr. 15, 2019

(30) Foreign Application Priority Data
Apr. 16, 2018 (DE) 10 2018 205 710.9

(51) Int. Cl. B60W 20/30; B60W 20/40

(52) U.S. Cl. CPC B60W 20/30; B60W 10/02; B60W 20/40

(57) ABSTRACT

A method for operating a drive train includes determining target torques for prime movers (1, 2) at least depending on a driver-demanded output torque. When a form-locking shift element (9) is disengaged for a gearchange, the shift element (9) to be disengaged is relieved of load, via an actuation of the prime movers depending on the target torques. The shift element (9) to be disengaged is already actuated with a defined actuating pressure in the direction of disengagement before a theoretical relief from load depending on the target torques, and monitoring determines whether and at which actual torques the shift element (9) to be disengaged begins to move. The actual torques of the prime movers (1, 2), at which the shift element (9) to be disengaged begins to move, are determined as actual torques at which the shift element (9) to be disengaged is actually relieved of load.

The invention relates generally to a method and a control unit for operating a drive train of a motor vehicle.

### BACKGROUND

From hybrid vehicles, drive trains for motor vehicles are known, which include multiple prime movers, a transmission, and a driven end. It is known that the first prime mover acts on a first input shaft, and a second prime mover acts on another, second input shaft. A transmission output shaft differs from the first input shaft, on which the first prime mover acts, and from the second input shaft, on which the second prime mover acts. The first prime mover is preferably an internal combustion engine and the second prime mover is preferably an electric machine which can be operated as a motor and as a generator. The transmission of such a drive train includes multiple shift elements, wherein, in every engaged gear of the transmission, a first number of shift elements is engaged and a second number of shift elements is disengaged. In order to implement a gearchange from an actual gear into a target gear, a shift element, which is engaged in the actual gear and is disengaged in the target gear, is disengaged, and a shift element, which is disengaged in the actual gear and is engaged in the target gear, is engaged. For the case in which these are friction-locking shift elements, such as brakes or clutches, the disengagement and engagement of the involved shift elements can take place during the slip operation thereof. During slip operation, friction torques and drag torques occur, however, which negatively affect the fuel consumption of the motor vehicle. Form-locking shift elements, such as constant-mesh shift elements, in the case of which no friction torques occur during operation, are therefore being utilized to an increasing extent in transmissions of motor vehicles. In order to disengage such a form-locking shift element, the form-locking shift element must be relieved of load so that the form-locking shift element can be disengaged with a high level of comfort. In order to engage such a form-locking shift element, a synchronization of the particular shift element is necessary, i.e., a differential speed at shift-element halves of the particular form-locking shift element must be reduced before the engagement.

DE 10 2014 220 070 A1 describes a method for operating a drive train including multiple prime movers, wherein a first prime mover acts on a first input shaft and a second prime mover acts on a second, other input shaft. In order to implement a gearchange from an actual gear into a target gear, the shift element to be disengaged for the target gear is relieved of load with the aid of a torque-controlled operation of a first prime mover and with the aid of a torque-controlled operation of the second prime mover, wherein the shift element, which has been relieved of load, is subsequently disengaged. Thereafter, the rotational speed of the first prime mover and the rotational speed of the second prime mover are adapted to the target gear with the aid of a speed-controlled operation of the first prime mover and/or with the aid of a speed-controlled operation of the second prime mover, so that the shift element to be engaged for the target gear is synchronized. Thereafter, the shift element to be engaged is engaged.

DE 10 2010 061 824 A1 describes one further method for operating a drive train including multiple prime movers and a transmission. The transmission includes multiple form-locking shift elements. A planetary transmission cooperates with the transmission. A bypass shift element cooperates with the planetary transmission. The bypass shift element is a form-locking shift element which can be relieved of load by setting target torques at both prime movers. For the case in which the particular target torque has been reached at both prime movers, the bypass shift element can be disengaged without load. Moreover, it is provided to detect the torques of the two prime movers, at which the bypass shift element is actually disengaged. These torques are stored and are utilized within the scope of an adaptation for the next disengagement process of the bypass shift element.

### SUMMARY OF THE INVENTION

Example aspects of the invention provide a new type of method for operating a drive train of a motor vehicle and creating a control unit for carrying out the method.

The method according to the invention is utilized for operating a drive train of a motor vehicle, which includes multiple prime movers, a transmission, and a driven end, and wherein the transmission includes multiple shift elements. Preferably, a first prime mover acts on a first input shaft, and a second prime mover preferably acts on a second input shaft. The method according to the invention includes at least the following steps. In order to implement a gearchange from an actual gear into a target gear, a shift element, which is engaged in the actual gear and is disengaged in the target gear, is disengaged, and a shift element, which is disengaged in the actual gear and is engaged in the target gear, is engaged. In order to implement the gearchange, target torques are determined for the first and the second prime movers at least depending on a driver-demanded output torque. For the case in which a form-locking shift element is disengaged for the gearchange to be implemented, the form-locking shift element to be disengaged is relieved of load or is approximately relieved of load, via an actuation of the first and the second prime movers depending on the calculated target torques, in such a way that, while providing a load transfer, the target torque is decreased at one of the prime movers and the target torque is increased at another one of the prime movers, in order to disengage the shift element to be disengaged in a load-free or approximately load-free manner while providing the driver-demanded output torque at the driven end. The form-locking shift element to be disengaged is already actuated with a defined actuating pressure or a defined actuating force in the direction of disengagement during the load transfer, before a theoretical relief from load or a theoretical approximate relief from load depending on the target torques. Monitoring is carried out to determine whether and at which actual torques of the first and the second prime movers the form-locking shift element to be disengaged begins to move. The actual torques of the first and the second prime movers, at which the form-locking shift element to be disengaged begins to move, are determined as actual torques at which the form-locking shift element to be disengaged has actually been relieved of load or has been approximately relieved of load.

With the aid of the present invention, a form-locking shift element of a transmission can be disengaged in a particularly advantageous manner.

In order to relieve or approximately relieve the load on the form-locking shift element to be disengaged, a load transfer takes place on the basis of target torques for the two prime movers. During the load transfer, the target torque is increased at one of the prime movers and the target torque is decreased at another one of the other prime movers, in order to relieve the form-locking shift element to be disengaged of load while maintaining the driver-demanded output torque.

Even before the theoretical relief from load or the theoretical approximate relief from load, the form-locking shift element to be disengaged is actuated during the load transfer with the defined actuating pressure or the defined actuating force.

Monitoring is carried out to determine whether and at which actual torques of the prime movers the form-locking shift element to be disengaged begins to move. These torques are detected in order to determine, in this way, the actual torques, which are applied by the prime movers, at which the form-locking shift element to be disengaged is actually load-free or approximately load-free.

According to one advantageous refinement of the invention, the target torques are adapted depending on a deviation between the target torques of the first and the second prime movers, which bring about a theoretical relief from load or a theoretical approximate relief from load of the form-locking shift element to be disengaged, and the actual torques of the first and the second prime movers, at which the form-locking shift element to be disengaged has actually been relieved of load or has been approximately relieved of load. In this way, an adaptation for the target torques of the prime movers can be made available in a particularly advantageous manner. In a subsequent disengagement of a form-locking shift element, the disengagement can then take place with higher quality.

According to one advantageous refinement of the invention, a point in time is determined, depending on the target torques of the prime movers, at which the form-locking shift element to be disengaged is theoretically relieved of load or is theoretically approximately relieved of load. Already during a defined interval before this point in time of the theoretical relief from load or approximate relief from load, the shift element to be disengaged is actuated with the defined actuating pressure or the defined actuating force in the direction of disengagement during the load transfer. For the case in which it is detected that the form-locking shift element to be disengaged begins to move within this interval or at the determined point in time, the corresponding actual torques of the first and the second prime movers are determined, the load transfer is terminated, and the form-locking shift element to be disengaged is actuated with a higher actuating pressure or a greater actuating force for complete disengagement. For the case in which the shift element to be disengaged does not begin to move at the defined point in time, the shift element to be disengaged is actuated with the defined actuating pressure or the defined actuating force in the direction of disengagement for, at most, a defined interval after this point in time while the load transfer continues or during an equidirectional increase and/or reduction of the target torques of the first and the second prime movers. For the case in which it is detected that the form-locking shift element to be disengaged begins to move within the maximum permissible interval after the determined point in time of the theoretical relief from load or approximate relief from load, the actual torques of the prime movers are determined, the load transfer or the equidirectional increase and/or reduction of the target torques of the first and the second prime movers is terminated, and the form-locking shift element to be disengaged is actuated with a higher actuating pressure or a greater actuating force for complete disengagement. For the case in which it is detected that the form-locking shift element to be disengaged does not begin to move within the interval after the determined point in time of the theoretical relief from load or approximate relief from load, the load transfer or the optional equidirectional increase and/or reduction of the target torques of the first and the second prime movers is terminated, and the form-locking shift element to be disengaged is actuated with a higher actuating pressure or a greater actuating force for complete disengagement.

With the aid of these details, the actual torques of the prime movers, with the aid of which the form-locking shift element to be disengaged has actually been relieved of load or approximately relieved of load, can be determined in a particularly advantageous manner. The equidirectional increase and/or reduction of the target torques for the prime movers is advantageous for the case in which the torque deviations are equidirectional at both prime movers, i.e., the torque deviations cannot cancel each other out. The equidirectional increase and/or reduction of the target torques at the prime movers is preferably carried out when it could not be determined, during a preceding gearchange, that the form-locking shift element to be disengaged begins to move during the load transfer.

Preferred refinements result from the following description.

### BRIEF DESCRIPTION OF THE DRAWINGS

Exemplary embodiments of the invention are explained in greater detail with reference to the drawings, without being limited thereto. Wherein:

FIG. 1 shows a diagram of a drive train of a motor vehicle;

FIG. 2 shows timing charts for illustrating the phases of a gearchange;

FIG. 3 shows timing charts for illustrating the invention;

FIG. 4 shows timing charts for further illustrating the invention; and

FIG. 5 shows a block diagram for further illustrating the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The present invention relates to a method for operating a drive train of a motor vehicle, which includes an automatic or automated transmission, and a control unit for carrying out the method.

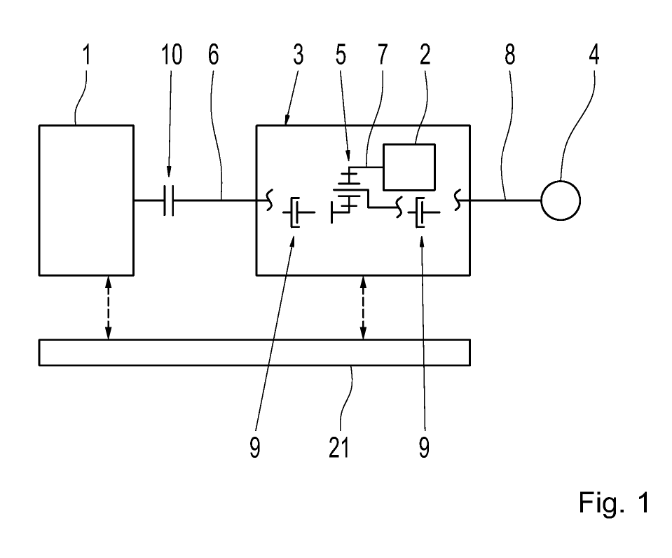

FIG. 1 shows a diagram of a drive train of a motor vehicle, in which the method according to the invention is preferably utilized. The drive train from FIG. 1 includes two prime movers 1, 2, a transmission 3, and a driven end 4. The transmission 3 preferably includes one planetary gear stage 5.

The two prime movers 1, 2 act on different input shafts or transmission shafts of the transmission 3, namely the first prime mover 1 acts on a first input shaft 6 and the second prime mover 2 acts on another, second input shaft 7. The prime movers 1 and 2 do not have a constant transmission ratio, but rather a variable transmission ratio with respect to one another. The two input shafts 6, 7 are different from a transmission output shaft 8.

In the exemplary embodiment shown, the first prime mover 1 is an internal combustion engine which acts on the first input shaft 6 which, in the exemplary embodiment shown, is the transmission input shaft of the transmission 3. In the exemplary embodiment shown, the second prime mover 2 is an electric machine which acts on the second input shaft 7, i.e., a second transmission shaft of the transmission 3, wherein, in the exemplary embodiment shown, the second input shaft 7 is made available by the planetary gear stage 5, namely by a ring gear thereof, in the exemplary embodiment shown. It is pointed out that, alternatively, both prime movers 2 and 3 can be electric machines.

The transmission output shaft 8 of the transmission 3 acts on a driven end 4 of the drive train in order to ultimately make a driver-input torque available at the driven end 4. The transmission output shaft 8 corresponds to the output shaft. In the shown exemplary embodiment from FIG. 1, the first prime mover 1 is a transmission-external prime mover and the prime mover 2 is a transmission-internal prime mover.

According to FIG. 1, the transmission 3 includes multiple shift elements 9, wherein only two shift elements 9 are shown, by way of example, in FIG. 1. A first shift element 9 according to FIG. 1 is connected between the transmission input shaft 6 and the planetary gear stage 5, and a second shift element 9 is connected between the planetary gear stage 5 and the transmission output shaft 8. In the exemplary embodiment shown, both shift elements 9 are form-locking shift elements, for example, constant-mesh shift elements.

In the exemplary embodiment from FIG. 1, a separating clutch 10 is connected between the first prime mover 1 and the transmission input shaft 6 of the transmission 3. The separating clutch 10 is preferably designed as a friction-locking clutch, wherein the first prime mover 1 can be decoupled from the transmission input shaft 6 with the aid of the separating clutch. The separating clutch 10 is an optional assembly and can even be dispensed with.

FIG. 1 also shows a control unit 21 which, in the exemplary embodiment shown, controls the operation of the first prime mover 1 and the transmission 3, including the second prime mover 2, by way of an open-loop and/or closed-loop system.

This control unit 21 is preferably a hybrid control unit. According to the dashed-line arrows, the control unit 21 exchanges data with the first prime mover 1 as well as with the transmission 3 in order to control the operation of the first prime mover 1, the transmission 3, and the second prime mover 2 by way of an open-loop and/or closed-loop system.

For the case in which a gear has been engaged in the transmission 3, a first number of shift elements 9 of the transmission 3 is engaged and a second number of shift elements 9 of the transmission 3 is disengaged. In order to implement a gearchange in the transmission 3 from an actual gear into a target gear, a shift element 9, which is engaged in the target gear, must be disengaged, and a shift element 9, which is disengaged in the actual gear, must be engaged, wherein the invention relates to details for disengaging a form-locking shift element 9 during such a gearchange.

At least for the purpose of implementing a gearchange and also for driving while the actual gearchange is not being implemented, target torques for operating the first prime mover 1 and the second prime mover 2 are determined at least depending on a driver-demanded output torque and preferably also depending on a specified power distribution between the first prime mover 1 and the second prime mover 2 and/or depending on an actual gear and/or depending on a target gear and/or depending on a specified shifting speed and/or depending on an actual output speed.

In this case, it is preferably provided, at least for implementing a gearchange and preferably also for driving while the actual gearchange is not being implemented, to determine the target torques for the first prime mover 1 and the second prime mover 2 in such a way that the particular target torque is composed of a static torque component and a dynamic torque component in each case. The particular static torque component determines a basic distribution of energy between the two prime movers 1 and 2. The particular dynamic torque component is utilized for dynamic compensation.

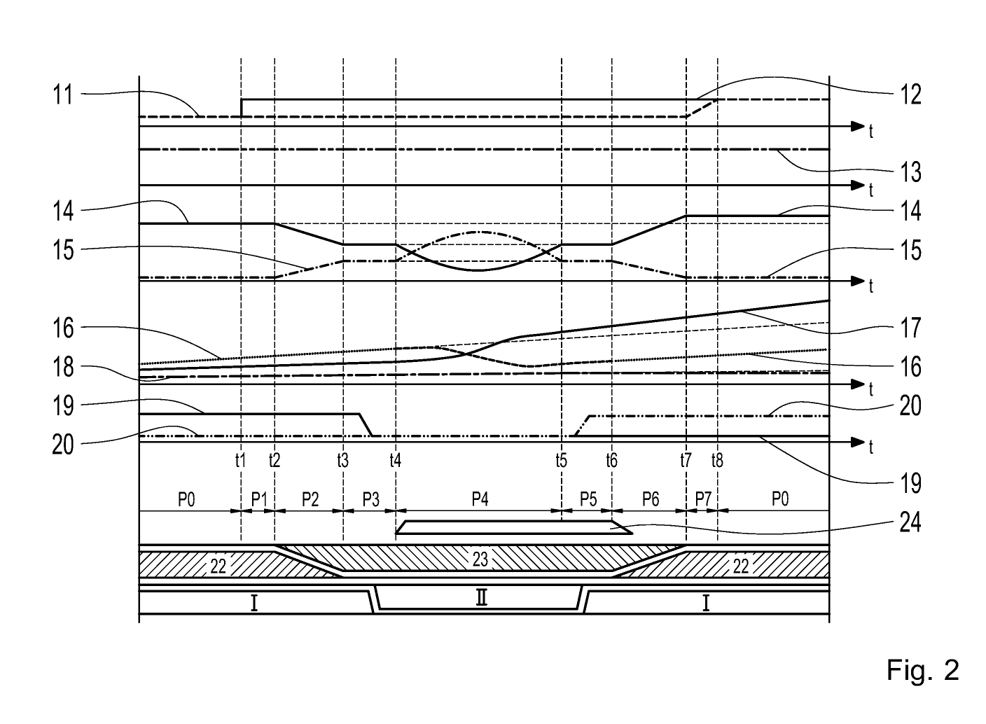

Details regarding a gearchange from an actual gear into a target gear are described with reference to FIG. 2, wherein curve profiles which can form during the implementation of a gearchange are shown in FIG. 2. FIG. 2 shows multiple curve profiles 11 to 20, which can form during implementation of a gearchange. Curve profile 11 represents an actual gear of a gear shift to be implemented. Curve profile 12 represents a desired gear of a gear shift to be implemented. Curve profile 13 represents a driver-demanded output torque. Curve profile 14 represents a target torque of the first prime mover 1. Curve profile 15 represents a target torque of the second prime mover 2. Curve profile 16 represents an actual rotational speed of the first prime mover 1. Curve profile 17 represents an actual rotational speed of the second prime mover 2. Curve profile 18 represents an output speed. Curve profile 19 represents the condition of a shift element 9 to be disengaged. Curve profile 20 represents the condition of a shift element 9 of the transmission 3 to be engaged. FIG. 2 also illustrates phases P1 to P7 of the gearchange, namely a phase P1 “initialization”, a phase P2 “load transfer”, a phase P3 “decoupling”, a phase P4 “speed transition”, a phase P5 “coupling”, a phase P6 “return of load”, and a phase P7 “conclusion”. The phases P2 to P6 are to be associated with the actual gearchange. The phases P1 and P7 lie outside the actual gearchange. A phase P0 indicates normal driving at a constant drive ratio without a shift request. A transition between the individual phases P0 to P7 takes place at the times t1, t2, t3, t4, t5, t6, t7 and t8. The transition between the individual phases takes place on the basis of transition conditions predefined on the control side.

For driving while the actual gearchange is not being implemented, i.e., for the phases P0, P1, and P7, the target torque for the first prime mover 1 is preferably determined according to the following equations (1) to (3):

$$\begin{matrix}{M}_{VM - SOLL} = {M}_{{VM}_{FG}} = {M}_{{VM}_{FG - stat}} + {M}_{{VM}_{FG - dyn}} & ( 1 ) \\ {M}_{{VM}_{FG - stat}} = {M}_{{ab}_{W}} \times \frac{{proz}_{hyb}}{{i}_{{VM}_{Gx}}} & ( 2 ) \\ {M}_{{VM}_{FG - dyn}} = {J}_{{red}_{Gx}} \times \frac{( 1 - {proz}_{hyb} )}{{i}_{{VM}_{Gx}}} \times \frac{PI}{30} \times \frac{d}{dt} ( {n}_{ab} ) & ( 3 )\end{matrix}$$

For driving while the actual gearchange is not being implemented, i.e., for the phases P0, P1, and P7, the target torque for the second prime mover 2 is preferably determined according to the following equations (4) to (6):

$$\begin{matrix}{M}_{EM - SOLL} = {M}_{{EM}_{PG}} = {M}_{{EM}_{FG - stat}} + {M}_{{Em}_{FG - dyn}} & ( 4 ) \\ {M}_{{EM}_{FG - stat}} = {M}_{{ab}_{w}} \times \frac{{proz}_{hyb}}{{i}_{{EM}_{Gx}}} & ( 5 ) \\ {M}_{{EM}_{FG - dyn}} = {J}_{{red}_{Gx}} \times \frac{{proz}_{hyb}}{{i}_{{EM}_{GX}}} \times \frac{PI}{30} \times \frac{d}{dt} ( {n}_{ab} ) & ( 6 )\end{matrix}$$

wherein
M_{EM}_{_{PG}} is the target torque M_{EM-SOLL} for the second prime mover,
M_{EM}_{_{PG-stat}} is the static torque component of the target torque for the second prime mover,
M_{EM}_{_{PG-dyn}} is the dynamic torque component of the target torque for the second prime mover,
M_{VM}_{_{FG}} is the target torque M_{VM-SOLL} for the first prime mover,
M_{VM}_{_{FG-stat}} is the static torque component of the target torque for the first prime mover,
M_{VM}_{_{FG-dyn}} is the dynamic torque component of the target torque for the first prime mover,
M_{ab}_{_{w}} is the driver-demanded output torque,
proz_{hyb} is the specified power distribution between the first and the second prime movers,
I_{EM}_{_{Gx}} is an operative transmission ratio of the actual gear for the second prime mover,
i_{VM}_{_{Gx}} is an operative transmission ratio of the actual gear for the first prime mover,
I_{red}_{_{Gx}} is a reduced inertia moment of the overall drive in the current actual gear relative to a transmission output shaft,
n_{ab} is the actual output speed, and
PI is the constant π.

The determination of the target torques M_{VM-SOLL} and M_{EM-SOLL} for the two prime movers 1, 2 according to the equations (1) to (6) is illustrated in FIG. 2 with the aid of a block 22.

For the actual implementation of a gearchange and, in fact, for the phases P3, P4, and P5, the target torque for the first prime mover 1 is determined according to the following equations (7) to (9):

$$\begin{matrix}{M}_{VM - SOLL} = {M}_{{VM}_{GW}} = {M}_{{VM}_{GW - stat}} + {M}_{{VM}_{GW - dyn}} & ( 7 ) \\ {M}_{{VM}_{GW - stat}} = {M}_{{ab}_{w}} \times \frac{1}{{i}_{{G}^{*}}} \times \frac{{i}_{{0}^{*}}}{( {i}_{{0}^{*}} - 1 )} & ( 8 ) \\ {M}_{{VM}_{GW - dyn}} = ( {J}_{1} + {J}_{13} ) \times {i}_{{VM}_{soll}} \times \frac{PI}{30} \times \frac{d}{dt} ( {n}_{ab} ) & ( 9 )\end{matrix}$$

For the actual implementation of a gearchange, i.e., for the phases P3, P4, and P5, the target torque for the second prime mover 2 is determined according to the following equations (10) to (12):

$$\begin{matrix}{M}_{EM - SOLL} = {M}_{{EM}_{GW}} = {M}_{{EM}_{GW - stat}} + {M}_{{EM}_{GW - dyn}} & ( 10 ) \\ {M}_{{EM}_{GW - stat}} = {M}_{{ab}_{w}} \times \frac{1}{{i}_{{G}^{*}}} \times \frac{1}{( 1 - {i}_{{G}^{*}} )} & ( 11 ) \\ {M}_{{Em}_{GW - dyn}} = ( {J}_{3} + {J}_{31} ) \times [ {i}_{{0}^{*}} \times {i}_{{VM}_{soll}} - ( {i}_{{0}^{*}} - 1 ) ] \times \frac{PI}{3 G} \times \frac{d}{dt} ( {n}_{ab} ) & ( 12 )\end{matrix}$$

wherein
M_{EM}_{_{GW}} is the target torque M_{EM-SOLL} for the second prime mover,
M_{EM}_{_{GW-stat}} is the static torque component of the target torque for the second prime mover,
M_{EM}_{_{GW-dyn}} is the dynamic torque component of the target torque for the second prime mover,
M_{VM}_{_{GW}} is the target torque M_{VM-SOLL} for the first prime mover,
M_{VM}_{_{GW-stat}} is the static torque component of the target torque for the first prime mover,
M_{VM}_{_{GW-dyn}} is the dynamic torque component of the target torque for the first prime mover,
M_{ab}_{_{w}} is the driver-demanded output torque,
I₃ is an inertia moment of the second input shaft.
I₃₁ is a coupling inertia moment of a planetary gear set relative to the first input shaft,
I₁ is an inertia moment of the first input shaft.
I₁₃ is a coupling inertia moment of the planetary gear set relative to the second input shaft.
i_{0*} is a coupling ratio of the planetary gear set,
i_{G*} is an output ratio of the planetary gear set,
i_{VM}_{ₛₒₗₗ} is a ratio for the first prime mover in the target gear,
n_{ab} is the actual output speed, and
PI is the constant π.

The determination of the target torques M_{VM-SOLL} and M_{EM-SOLL} for the two prime movers 1, 2 according to the equations (7) to (12) is illustrated in FIG. 2 with the aid of a block 23.

During the phases P2 and P6, i.e., during the phase P2 “load transfer” and the phase P6 “return of load”, equations (1) to (6) as well as the equations (7) to (12) apply for the determination of the target torques M_{VM-SOLL} and M_{EM-SOLL} for the two prime movers 1 and 2.

During the phases P2 “load transfer” and P6 “return of load”, first target torques for the prime movers 1 and 2 are determined according to the equations (1) to (6) and second target torques for the prime movers 1 and 2 according to the equations (7) to (12). The following therefore applies in the phases P2 “load transfer” and P6:

M_{VM-SOLL}=f(M_{VM}_{_{PG}},M_{BM}_{_{GW}}) (13)

M_{EM-SOLL}=f(M_{EM}_{_{PG}},M_{EM}_{_{GW}}) (14)

During the phase P2 “load transfer”, a transition takes place from the first target torques of the block 23 “driving gear” to the second target torques of the block 24 “power distribution”, preferably linearly in a timed manner.

During the phase P6 “return of load”, a transition takes place from the second target torques of the block 24 “power distribution” to the first target torques of the block 23 “driving gear”, preferably linearly in a timed manner once again.

In the phases P4 “speed transition” and P5 “coupling”, a speed controller 24 (see FIG. 2) can be advantageously activated in order to determine further dynamic torque components for the target torques of the prime movers 1 and 2 for the phases P4 and P5 and, if necessary, P6 as well.

In the speed controller, at least one actual speed profile of one of the prime movers 1, 2 forming as a result of the target torques of the prime movers 1, 2 is compared with a corresponding specified speed profile of the particular prime mover 1, 2, wherein, in the case of a deviation, the speed controller 24 intervenes in an assisting manner in order to bring the actual speed of the particular prime mover up to the specified speed thereof. In this case, the rotational speed of the first prime mover 1, in particular of the internal combustion engine, as well as the rotational speed of the second prime mover 2, in particular of the electric machine, can be controlled by a closed-loop system with the aid of the speed controller 24.

According to a first variant, the further dynamic torque components of the target torque for the first prime mover 1 and for the second prime mover 2 are determined with the aid of the speed controller 24, including bringing the rotational speed up to the rotational speed of the first prime mover 1, as follows:

M_{EM}_{_{Reg}}=(J₃+J₃₁)×i_{0*}×PID[n_{VM}_{ₛₒₗₗ}−n_{VM}_{ᵢₛₜ}] (14)

M_{VM}_{_{Reg}}=(J₁+J₁₃)×PID[n_{VM}_{ₛₒₗₗ}−n_{VM}_{ᵢₛₜ}] (15)

wherein
M_{EM}_{_{Reg}} is the further dynamic torque component of the target torque for the second prime mover,
M_{VM}_{_{Reg}} is the further dynamic torque component of the target torque for the first prime mover,
I₃ is an inertia moment of the second input shaft,
I₃₁ is a coupling inertia moment of a planetary gear set relative to the first input shaft,
I₁ is an inertia moment of the first input shaft,
I₁₃ is a coupling inertia moment of the planetary gear set relative to the second input shaft,
i_{0*} is a coupling ratio of the planetary gear set,
n_{VM}_{ₛₒₗₗ} is a specified speed of the first prime mover for a PID control function,
n_{VM}_{ᵢₛₜ} is an actual speed of the first prime mover for the PID control function, and
PID is a PID control function.

According to a second variant, the dynamic torque components of the target torques for the prime movers 1 and 2 are determined, with the aid of the speed controller 24, including bringing the rotational speed up to the rotational speed of the second prime mover 2, as follows:

$$\begin{matrix}{M}_{{EM}_{Reg}} = ( {J}_{3} + {J}_{31} ) \times PID [ {n}_{{EM}_{soll}} - {n}_{{EM}_{int}} ] & ( 16 ) \\ {M}_{{VM}_{Reg}} = ( {J}_{1} + {J}_{13} ) \times \frac{1}{{i}_{{0}^{*}}} \times PID [ {n}_{{EM}_{soll}} - {n}_{{EM}_{int}} ] & ( 17 )\end{matrix}$$

wherein
M_{EM}_{_{Reg}} is the further dynamic torque component of the target torque for the second prime mover,
M_{VM}_{_{Reg}} is the further dynamic torque component of the target torque for the first prime mover,
I₃ is an inertia moment of the second input shaft,
I₃₁ is a coupling inertia moment of a planetary gear set relative to the first input shaft,
I₁ is an inertia moment of the first input shaft,
I₁₃ is a coupling inertia moment of the planetary gear set relative to the second input shaft,
i_{0*} is a coupling ratio of the planetary gear set,
n_{EM}_{ₛₒₗₗ} is a specified speed of the second prime mover for a PID control function,
n_{EM}_{ᵢₙₜ} is an actual speed of the second prime mover for the PID control function, and
PID is a PID control function.

The speed controller 24 outputs, as output parameters, the further dynamic torque components of the target torque of the two prime movers 1, 2. In the case of an active speed controller 24, the following applies:

M_{VM}_{_{GW}}=M_{VM}_{_{GW-stat}}+M_{VM}_{_{GW-dyn}}+M_{VM}_{_{Reg}} (18)

M_{EM}_{_{GW}}=M_{EM}_{_{GW-stat}}+M_{EM}_{_{GW-dyn}}+M_{EM}_{_{Reg}} (19)

FIG. 2 shows the curve profiles 11 to 20 for a special case of the implementation of a gearchange with a constant driver-demanded output torque 13, wherein, during the phase P0 “normal driving” in a fixed actual gear, the complete drive torque is made available by the first prime mover 1, but no output torque is made available by the second prime mover 2. Before the point in time t1, the shift element 20 to be engaged is in the disengaged condition and the shift element 19 to be disengaged is in the engaged condition.

Before the point in time t1, the motor vehicle is operated in the phase P0 in an engaged actual gear without a shift request at a constant drive ratio. Therefore, according to the signal curve 12, there is no shift request. According to the signal curve 13, the driver-demanded output torque is constant. According to the signal curve 14, only the first prime mover 1 makes a torque available at the driven end. According to the signal curve 15, the second prime mover does not make any output torque available.

At the point in time t1, there is a shift request. Starting at the point in time t1, the actual gear therefore deviates from the target gear, according to the curve profiles 11 and 12, and so, at the point in time t1, a transition takes place to the phase P1 “initialization of the gear shift implementation”. During the phase P1 “initialization”, the transition from normal driving into the actual shift sequence beginning with the phase P2 “load transfer” is coordinated, wherein shift-specific requirements such as the target gear, the shifting speed, the selection of the involved shift elements, and the like, are determined.

In addition, conditioning requirements can also be output in the phase P1 “initialization”, such as a torque reserve for the first prime mover, or the like.

At the point in time t2, a transition takes place from the phase P1 “initialization” into the phase P2 “load transfer”.

During the phase P2, the target torque for the first prime mover and the target torque for the second prime mover are determined via the equations (1) to (6) within the scope of the block 22 as well as via the equations (7) to (12) within the scope of the block 23, wherein a transition takes place here from the target torques predefined by the block 22 to the target torques predefined by the block 23. During the phase P2 “load transfer”, the shift element to be disengaged is unloaded with the aid of the target torques of the prime movers and, therefore, is relieved of load or is approximately relieved of load.

At the point in time t3, a transition to the phase P3 “decoupling” takes place, wherein, during the phase P3, according to the signal curve 19, the shift element to be disengaged for the gearchange is transferred from the engaged condition into the disengaged condition. In so doing, the transmission 3 changes over from a condition I “coupled” (see FIG. 2) into a condition II “decoupled” (see FIG. 2). Due to the disengagement of the shift element to be disengaged, one additional rotational degree of freedom between the prime movers 1 and 2 is made available in the transmission 3. This additional degree of freedom is a precondition for the subsequent speed transition in the phase P4 “speed transition”.

In the phase P4 “speed transition”, the rotational speeds are transitioned, in a controlled manner, to the new specified speed determined on the basis of the new target gear with the aid of a transition function which is preferably an S-shaped transition function. A specified speed can be either a specified speed of the first prime mover 1 or, alternatively, a specified speed of the second prime mover 2. For the purpose of stabilization, the speed controller 24 is preferably activated in the phase P4.

After the speed transition in the phase P4, a transition takes place at the point in time t5 to the phase P5 “coupling”, wherein the speed controller 24 remains active in the phase P5. In the phase P5, after the speed transition has taken place, the new ratio of the target gear is made available with the aid of the shift element to be engaged in the phase P5 according to the signal curve 20, and the additional degree of freedom between the prime movers 1 and 2, which was acquired in the phase P3, is eliminated in the phase P5.

In the phase P6, a return of load takes place, wherein, in the phase P6, the target torques for the prime movers are determined via the equations (1) to (6) within the scope of the block 22 as well as via the equations (7) to (12) within the scope of the block 23, wherein a transition from the target torques of the block 23 to the target torques of the block 22 takes place. A complete return of load, as shown in FIG. 2, is not absolutely necessary.

In the phase P7, the gearchange is concluded and a coordinated transition back into the normal driving operation of the phase P0 takes place. In the phase P7, special conditioning requirements or feedback can be communicated in order to analyze the shift sequence and, therefore, the gearchange.

As mentioned above, the present invention relates to those details of a gearchange, which are utilized for relieving or approximately relieving the load of a form-locking shift element 9 of the transmission, which is to be disengaged for the gearchange to be implemented.

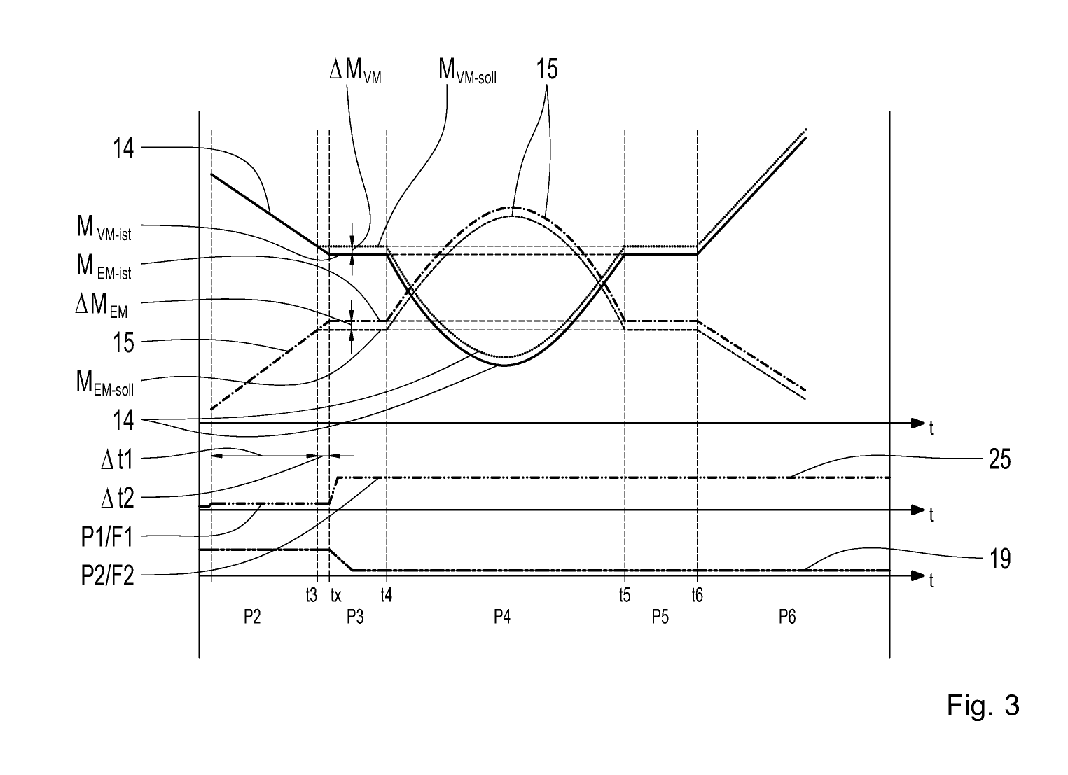

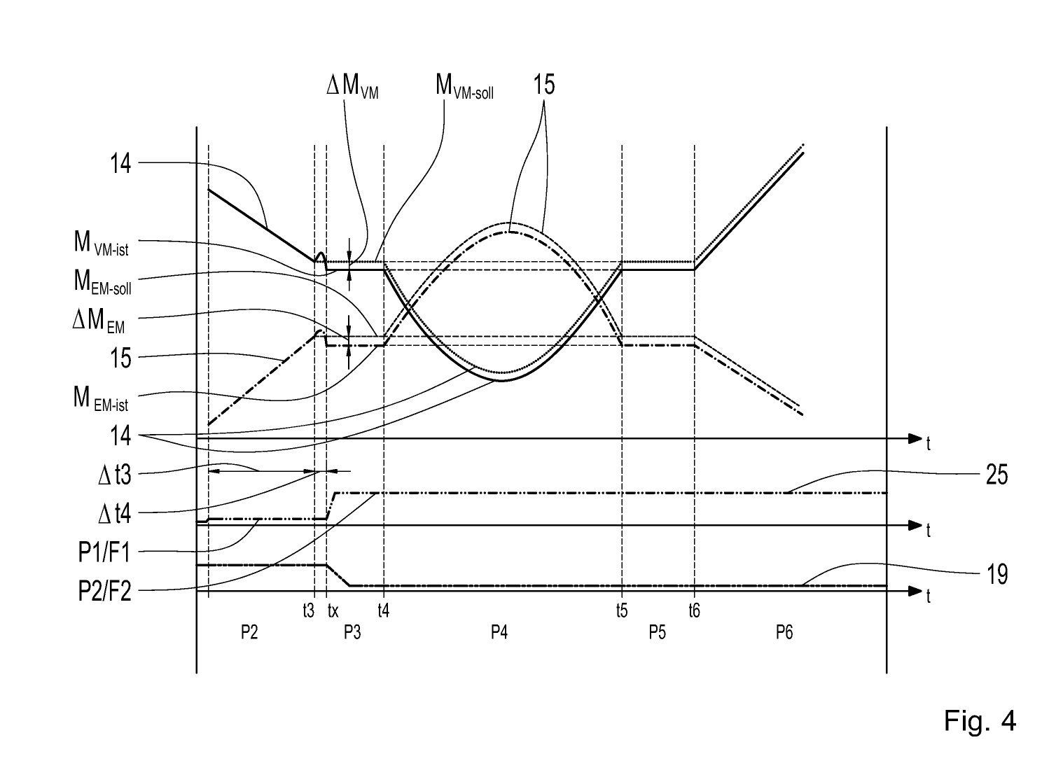

These details are described in greater detail in the following with reference to FIGS. 3 and 4, wherein FIGS. 3 and 4 show the actuation of the shift element 9 to be disengaged with a defined pressure or a defined force for the phases P2, P3, P4, P5, and P6, as a further curve profile 25, in addition to the curve profiles 14, 15, and 19.

As mentioned above, target torques M_{VM-SOLL} and M_{EM-SOLL} are calculated for implementing a gearchange for the above-described phases for both prime movers 1, 2. In order to now relieve or approximately relieve the load of the form-locking shift element 9, which is to be disengaged for the gearchange, during the phase P2, the two prime movers 1 and 2 are actuated during the phase P2 depending on the calculated target torques M_{VM-SOLL} and M_{EM-SOLL} while providing a load transfer, wherein, during a load transfer, the target torque is reduced at one of the prime movers and the target torque is increased at another one of prime movers, in order to relieve or approximately relieve the load of the shift element 9 to be disengaged, and to subsequently disengage the shift element 9 without load or approximately without load, while maintaining the driver-demanded output torque at the driven end 4.

Thus, FIG. 3 shows that, in the exemplary embodiment shown, during the phase P2, the target torque M_{VM-SOLL} of the first prime mover 1 is reduced, according to the curve profile 14, and the target torque M_{EM-SOLL} at the second prime mover 2 is increased, according to the curve profile 15.

Depending on the target torques M_{VM-SOLL} and M_{EM-SOLL}, which are utilized for actuating the two prime movers 1 and 2, a point in time can be determined, at which the form-locking shift element 9 to be disengaged is theoretically relieved of load or is theoretically approximately relieved of load. This is the case at the point in time t3 in FIG. 3. The point in time t3 in FIG. 3 therefore corresponds to the point in time at which the form-locking shift element 9 to be disengaged is theoretically relieved of load or is theoretically approximately relieved of load, depending on the target torques 14, 15 or M_{VM-SOLL}, M_{EM-SOLL}.

According to FIG. 3, the form-locking shift element 9 to be disengaged is actuated with a defined actuating pressure or a defined actuating force in the direction of disengagement already before the point in time t3, i.e., before the theoretical relief from load or the theoretical approximate relief from load, wherein this defined actuating pressure or this defined actuating force is relatively low. This relatively low actuating pressure or this relative actuating force is visualized in FIG. 3 with the aid of p1/F1.

During the load transfer in the phase P2, i.e., in the phase in which the target torque is reduced at one of the prime movers and the target torque is increased at the other prime mover, and in which the form-locking shift element 9 to be disengaged has already been actuated with the defined actuating pressure or the defined actuating force p1/F1, monitoring is carried out to determine whether and at which actual torques of the two prime movers 1, 2 the form-locking shift element 9 to be disengaged begins to move. The actual torques of the prime movers 1, 2, at which the form-locking shift element 9 to be disengaged begins to move, are determined as actual torques at which the form-locking shift element 9 to be disengaged has actually been relieved of load or has been approximately relieved of load.

In FIG. 3, the point in time at which the shift element 9 to be disengaged is theoretically relieved of load or is theoretically approximately relieved of load, depending on the target torques 14 and 15, is marked as t3. Already in the defined first interval Δt1 before this point in time t3, the shift element 9 to be disengaged is actuated with the defined actuating pressure or the defined actuating force p1/F1 in the direction of disengagement during the load transfer in the phase P2.

For the case in which it is detected that the form-locking shift element 9 to be disengaged begins to move within the first interval Δt1 or at the determined point in time t3, the corresponding actual torques of the first prime mover 1 and the second prime mover 2 are determined, the load transfer is terminated, and the form-locking shift element 9 to be disengaged is actuated with a higher actuating pressure or a greater actuating force for complete disengagement. FIG. 3 shows an embodiment in which the shift element 9 to be disengaged does not begin to move until the defined point in time t3. Therefore, according to FIG. 3, the shift element 9 to be disengaged is actuated with a defined actuating pressure or a defined actuating force in the direction of disengagement beyond the point in time t3, as the load transfer continues, and, in fact, beyond the point in time t3 by a defined second interval Δt2. This defined second interval Δt2 is maximally limited. For the case in which it is detected that the form-locking shift element 9 to be disengaged begins to move within the maximally limited second interval Δt2, as is the case in FIG. 3 at the point in time tx, the corresponding actual torques M_{VM-IST} and M_{EM-IST} of the prime movers 1, 2 are determined, the load transfer is terminated, and the form-locking shift element 9 to be disengaged is actuated with a higher actuating pressure or a greater actuating force p2/F2 for complete disengagement, in order to therefore transition into the phase P3 “decoupling”. Due to the extended load transfer up to the point in time tx, the target torques 14 and 15 then deviate, in the subsequent phases, from the target torques 14 and 15 which would form if the load transfer has been terminated already at the point in time t3.

For the case in which the form-locking shift element 9 to be disengaged does not begin to move during the maximally limited, defined second interval Δt2 either, the load transfer is likewise terminated and the form-locking shift element 9 to be disengaged is actuated with an elevated actuating pressure or an elevated actuating force p2/F2 for complete disengagement, in order to bring the gearchange to an end within a defined permissible maximum shift time.

According to FIG. 3, a load transfer therefore takes place in the phase P2, in that the target torque 14, i.e., M_{VM-SOLL}, is reduced at the first prime mover and the target torque 15, i.e., M_{EM-SOLL} is increased at the second prime mover. At the point in time t3, the shift element to be disengaged is theoretically relieved or approximately relieved of load. If it is detected that the shift element 9 to be disengaged does not begin to move during the interval Δt1 before the point in time t3 is reached, despite the actuation to disengage, the load transfer and the actuation of the shift element, which is to be disengaged, with the defined actuating pressure or the defined actuating force p1/F1 are extended beyond the point in time t3 and, in fact, by the second interval Δt2 which is limited. If it is detected that the shift element 9 to be disengaged begins to move, the load transfer is terminated and the actuating pressure or the actuating force 25 p2/F2 for the shift element 9 to be disengaged is increased, in order to completely disengage the shift element 9.

Those target torques M_{VM-SOLL} and M_{EM-SOLL}, on the basis of which the shift element 9 to be disengaged was theoretically relieved of load or theoretically approximately relieved of load at the point in time t3, are visualized in FIG. 3. Moreover, the actual torques M_{VM-IST} and M_{EM-IST} are visualized, at which the form-locking shift element to be disengaged actually begins to move at the point in time tx and, therefore, is actually relieved of load or is approximately relieved of load. Moreover, deviations ΔM_{VM} and ΔM_{EM} are shown, i.e., amounts by which the actual torques M_{VM-IST} and M_{EM-IST} deviate from the corresponding target torques M_{VM-SOLL} and M_{EM-SOLL}.

On the basis of this deviation ΔM_{VM} and ΔM_{EM} between the target torques M_{VM-SOLL} and M_{EM-SOLL} of the prime movers 1 and 2, which bring about a theoretical relief from load or a theoretical approximate relief from load of the form-locking shift element 9 to be disengaged, and the actual torques M_{VM-IST} and M_{EM-IST} of the prime movers 1 and 2 at which the form-locking shift element 9 to be disengaged is actually relieved of load or is approximately relieved of load, the target torques for the prime movers can be adapted, in order to make an adapted target torque M_{VM-SOLL-A} and M_{EM-SOLL-A} available for the particular prime mover for a subsequent gearchange.

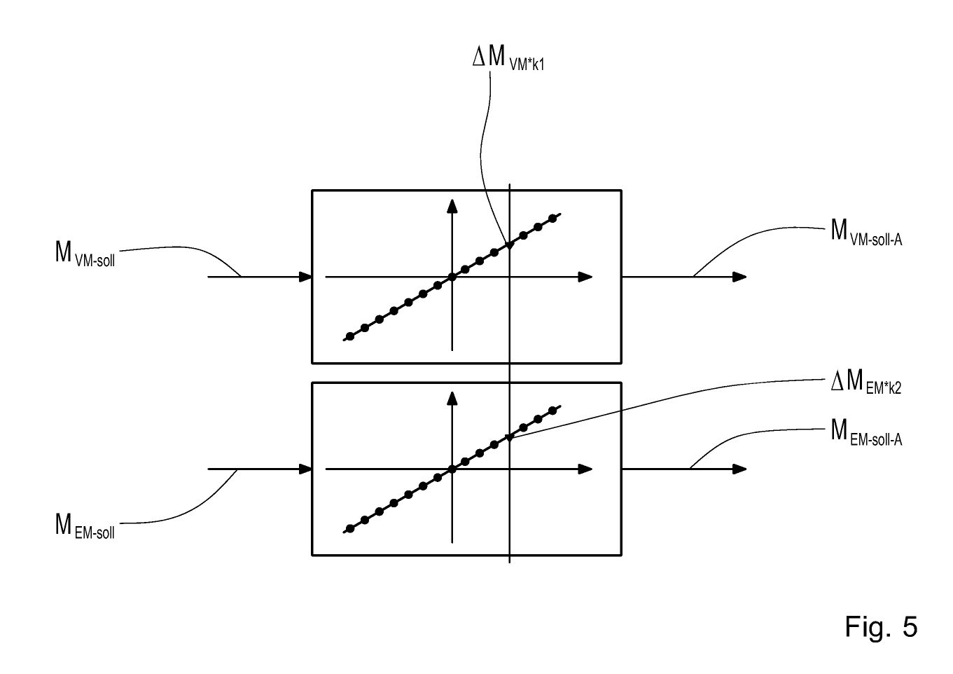

Thus, FIG. 5 shows a characteristic curve for each of the two target torques 14, 15, to which the torques M_{VM-SOLL} and M_{EM-SOLL} are made available as an input parameter, in order to make an adapted target torque and M_{EM-SOLL-A} available as an output parameter, wherein, in FIG. 5, the corresponding target torque M_{VM-SOLL} and M_{EM-SOLL} was adapted, depending on the deviation ΔM_{VM} and ΔM_{EM}, for a defined operating point. The adaptation preferably takes place across all operating points.

The adaptation preferably takes place in such a way that the deviations ΔM_{VM} and ΔM_{EM} are not utilized fully and, therefore, unfiltered, for correcting the target torques M_{VM-SOLL} and M_{EM-SOLL}, but rather are weighted with a factor k1 and k2, respectively, wherein the particular factor k1 and k2 is less than 1.

FIG. 4 shows a modification of FIG. 3. The phases P2, P3, P4, P5, and P6 of a gearchange are shown in FIG. 4.

In FIG. 4 as well, a point in time t3 for the prime movers 1, 2 is determined depending on the target torques 14, 15, i.e., M_{VM-SOLL}, M_{EM-SOLL}, at which the form-locking shift element 9 to be disengaged is theoretically relieved of load or is theoretically approximately relieved of load.

In FIG. 4 as well, a defined interval before this point in time t3 is marked, namely as the third interval in this case, during which the shift element 9 to be disengaged is actuated with the defined actuating pressure or the defined actuating force p1/F1 for disengagement, wherein this defined third interval is marked as Δt3 in FIG. 4.

Monitoring is carried out to determine whether the shift element 9 to be disengaged begins to move. If it is detected that the shift element to be disengaged begins to move within the interval Δt3 or at the point in time t3, the corresponding actual torques of the prime movers 1, 2 are determined, the load transfer is terminated, and the form-locking shift element 9 to be disengaged is actuated with a higher actuating pressure or a greater actuating force for complete disengagement.

A case is shown in FIG. 4, as is also shown in FIG. 3, in which the shift element 9 has not yet begun to move at the point in time t3, i.e., up to the point in time of the theoretical relief from load or the theoretical approximate relief from load, despite the actuation of the form-locking shift element 9 with the defined actuating pressure or the defined actuating force p1/F1.

Therefore, in FIG. 4, the target torques M_{VM-SOLL}, M_{EM-SOLL} of the prime movers 1, 2 are equidirectionally increased and/or decreased with a defined amplitude and a defined frequency, e.g., sinusoidally, after the point in time t3 of the theoretical relief from load or the theoretical approximate relief from load of the form-locking shift element 9 for a maximally limited, defined interval Δt4 after the point in time t3, wherein, in so doing, the form-locking shift element 9 is further actuated with the defined actuating pressure or defined actuating force p1/F1 in the direction of disengagement.

Therefore, in FIG. 3, while the load transfer is extended after the point in time t3, in that one of the target torques M_{VM-SOLL} or M_{VM-SOLL} is reduced and the other target torque M_{VM-SOLL} or M_{EM-SOLL} is similarly increased, in FIG. 4, after the point in time t3, the target torques M_{VM-SOLL}, M_{EM-SOLL} of the prime movers 1, 2 are equidirectionally increased and/or decreased with a defined amplitude and a defined frequency.

In FIG. 4, it is therefore detected, at the point in time tx, that the form-locking shift element to be disengaged begins to move in the defined interval Δt4 which is maximally limited on the control side, and so, at the point in time tx, the equidirectional increase and/or reduction of the target torques at the first prime mover 1 and the second prime mover 3 is terminated.

Moreover, beginning at the point in time tx, the form-locking shift element to be disengaged is actuated with a higher actuating pressure p2 or a greater actuating force F2 for complete disengagement in order to transition from the phase P2 of the load transfer into the phase P3 of decoupling at the point in time tx.

As a result of the equidirectional increase and/or decrease of the target torques for the prime movers 1 and 2 up to the point in time tx, the target torques 14 and 15 then deviate, in the subsequent phases, from the target torques 14 and 15 which would form if a transition into the phase P3 of decoupling would have taken place at the point in time t3.

While, in the exemplary embodiment of FIG. 3, the deviations ΔW_{VM} and ΔM_{EM} are such that they at least partially cancel each other out, the deviations ΔM_{VM} and ΔM_{EM} in FIG. 4 are such that they amplify one another. Therefore, in FIG. 4, the equidirectional increase and/or reduction of the target torques 14 and 15 for the prime movers 1 and 2 with a defined amplitude and frequency are/is necessary in order to actually relieve the load or actually approximately relieve the load of the form-locking shift element 9 to be disengaged, at the point in time tx.

For the case in which the form-locking shift element 9 to be disengaged does not begin to move during the defined fourth interval Δt4 of FIG. 4, despite the equidirectional increase and/or reduction of the target torques 14 and 15 of the two prime movers 1 and 2 and despite the actuation of the shift element 9, which is to be disengaged, with the defined actuating pressure or the defined actuating force p1/F1 in the direction of disengagement, the equidirectional increase and/or reduction of the target torques at the first and the second prime movers is nevertheless terminated and the form-locking shift element 9 to be disengaged is actuated with a higher actuating pressure and a greater actuating force for complete disengagement, in order to bring the gearchange to an end.

The variant of FIG. 4 is preferably carried out during a gearchange when, during a preceding gearchange of the same type, the variant of FIG. 3 did not induce the form-locking shift element 9, which is to be disengaged, to begin moving during the interval Δt1 or during the interval Δt2.

Therefore, in the variant of FIG. 3, if a movement of the form-locking shift element 9 to be disengaged was not detected during the interval Δt1 or during the interval Δt2, it is inferred that the shift element 9 could not be relieved of load or approximately relieved of load, and so, during a subsequent gearchange, the variant of FIG. 4 is selected in order to check whether the form-locking shift element 9 to be disengaged can be relieved of load or approximately relieved of load by utilizing this variant.

The check to determine whether the form-locking shift element 9 to be disengaged can be relieved of load or approximately relieved of load can take place with the aid of a position sensor associated with the form-locking shift element 9 to be disengaged.

With the aid of such a position sensor, monitoring can be directly carried out to determine whether a form-locking shift element 9 to be disengaged begins to move.

For the case in which the corresponding form-locking shift element 9 does not include a position sensor of this type, monitoring can also be indirectly carried out to determine whether the form-locking shift element 9 to be disengaged begins to move and, in fact, by evaluating a speed signal of the first prime mover 1 and/or a speed signal of the second prime mover 2 and/or a speed signal of the driven end 4. In this case, however, the defined actuating pressure or the defined actuating force p1/F1 during the particular interval Δt1, Δt2, Δt3, or Δt4 is higher than in the case in which the monitoring to determine whether a form-locking shift element 9 to be disengaged begins to move is carried out with the aid of a position sensor. With the aid of the elevated actuating pressure or the elevated actuating force p1/F1, a slight preloading and the speed reaction of the particular rotational speed to be evaluated is induced.

Since the actuating pressure or the defined actuating force is therefore selected to be higher in this case, in order to induce a speed reaction at one prime mover or both prime movers and/or at the driven end, the method is noticeable to the driver at the driven end.

In order to be able to carry out an adaptation, the torque threshold at which the form-locking shift element disengages with a defined actuating pressure or a defined actuating force must be known. This torque threshold is preferably determined in advance, via testing, as a function of a temperature and/or ageing, and is stored on the control side. In this case, the form-locking shift element is therefore approximately relieved of load and is disengaged approximately without load.

The invention also relates to a control unit for carrying out the method on the control side. In order to implement a gearchange from an actual gear into a target gear, the control unit 21 actuates a shift element, which is engaged in the actual gear and is disengaged in the target gear, to disengage, and actuates a shift element, which is disengaged in the actual gear and is engaged in the target gear, to engage. The control unit 21 determines, for the gearchange to be implemented, target torques for the first prime mover 1 and the second prime mover 2 at least depending on a driver-demanded output torque. For the case in which a form-locking shift element 9 is disengaged for the gearchange to be implemented, the control unit 21 relieves the load or approximately relieves the load of the form-locking shift element 9 to be disengaged, via an actuation of the first prime mover 1 and the second prime mover 2 depending on the calculated target torques, in such a way that, while providing a load transfer, the target torque is decreased at one of the prime movers 1 or 2 and the target torque is increased at another one of the prime movers 2 or 1, in order to disengage the shift element 9 to be disengaged in a load-free or approximately load-free manner while providing the driver-demanded output torque at the driven end 4.

The control unit actuates the form-locking shift element 9, which is to be disengaged, with a defined actuating pressure or a defined actuating force in the direction of disengagement during the load transfer, already before a theoretical relief from load or a theoretical approximate relief from load, which depends on the target torques. The control unit 21 monitors whether and at which actual torques of the first prime mover 1 and the second prime mover 2 the form-locking shift element 9 to be disengaged begins to move.

The control unit 21 determines the actual torques of the first prime mover 1 and the second prime mover 2 at which the form-locking shift element 9 to be disengaged begins to move, as actual torques at which the form-locking shift element 9 to be disengaged has actually been relieved of load or has been approximately relieved of load. Reference is made to the comments presented above with respect to further details.

Modifications and variations can be made to the embodiments illustrated or described herein without departing from the scope and spirit of the invention as set forth in the appended claims.

### REFERENCE CHARACTERS

1 first prime mover
2 second prime mover
3 transmission
4 driven end
5 planetary gear stage
6 first input shaft/transmission input shaft
7 second input shaft
8 transmission output shaft
9 shift element
10 separating clutch
11 curve profile/actual gear of a gear shift to be implemented
12 curve profile/desired gear of a gear shift to be implemented
13 curve profile/driver-demanded output torque
14 curve profile/target torque of the first prime mover
15 curve profile/target torque of the second prime mover
16 curve profile/actual torque of the first prime mover
17 curve profile/actual torque of the second prime mover
18 curve profile/output speed
19 curve profile/condition of shift element to be disengaged
20 curve profile/condition of shift element to be engaged
21 control unit
22 block
23 block
24 speed controller
25 curve profile/actuation of shift element to be disengaged

1-13: (canceled)

14. A method for operating a drive train of a motor vehicle, the drive train including a plurality of prime movers (1, 2), a transmission (3), and a driven end (4), the transmission (3) including a plurality of shift elements (9), the method comprising:
wherein, in order to implement a gearchange from an actual gear into a target gear, a shift element (9), which is engaged in the actual gear and is disengaged in the target gear, is disengaged, and a shift element (9), which is disengaged in the actual gear and is engaged in the target gear, is engaged;
in order to implement the gearchange, determining target torques for the first prime mover (1) and the second prime mover (2) at least depending on a driver-demanded output torque;
when a form-locking shift element (9) is disengaged for the gearchange to be implemented, relieving or approximately relieving the form-locking shift element (9) to be disengaged of load, via an actuation of the first prime mover (1) and the second prime mover (2) depending on the calculated target torques, in such a way that the target torque is decreased at one of the prime movers and the target torque is increased at another one of the prime movers, in order to disengage the shift element (9) to be disengaged in a load-free or approximately load-free manner while providing the driver-demanded output torque at the driven end (4);
wherein, the form-locking shift element (9) to be disengaged is already actuated with a defined actuating pressure or a defined actuating force in the direction of disengagement before a theoretical relief from load or a theoretical approximate relief from load depending on the target torques;
monitoring whether and at which actual torques of the first prime mover (1) and the second prime mover (2) the form-locking shift element (9) to be disengaged begins to move; and
determining the actual torques of the first prime mover (1) and the second prime mover (2) at which the form-locking shift element (9) to be disengaged begins to move as actual torques at which the form-locking shift element (9) to be disengaged has actually been relieved of load or has been approximately relieved of load.

15. The method as claimed in claim 14, further comprising adapring the target torques depending on a deviation between the target torques of the first prime mover (1) and the second prime mover (2), which bring about a theoretical relief from load or a theoretical approximate relief from load of the form-locking shift element (9) to be disengaged, and the actual torques of the first prime mover (1) and the second prime mover (2), at which the form-locking shift element (9) to be disengaged has actually been relieved of load or has been approximately relieved of load.

16. The method as claimed in claim 14, further comprising:
determining a point in time, depending on the target torques of the first prime mover (1) and the second prime mover (2), at which the form-locking shift element (9) to be disengaged is theoretically relieved of load or is theoretically approximately relieved of load;
already in a defined first interval before the determined point in time, actuating the shift element (9) to be disengaged with the defined actuating pressure or the defined actuating force in the direction of disengagement; and
in response to detecting that the form-locking shift element (9) to be disengaged begins to move within the first interval or at the determined point in time, determining the corresponding actual torques of the first prime mover (1) and the second prime mover (2), and actuating the form-locking shift element (9) to be disengaged by increasing an actuating pressure or an actuating force for complete disengagement.

17. The method as claimed in claim 16, further comprising:
when the shift element (9) to be disengaged does not begin to move at the defined point in time, actuating the shift element (9) to be disengaged with the defined actuating pressure or the defined actuating force in the direction of disengagement for, at most, a defined second interval after the determined point in time; or
in response to detecting that the form-locking shift element (9) to be disengaged begins to move, determining the actual torques of the prime movers (1, 2), and actuating the form-locking shift element (9) to be disengaged by increasing the actuating pressure or the actuating force for complete disengagement.

18. The method as claimed in claim 17, further comprising, when the form-locking shift element (9) to be disengaged does not begin to move during the defined second interval, actuating the form-locking shift element (9) to be disengaged by increasing the actuating pressure or the actuating force for complete disengagement.

19. The method as claimed in one of claim 14, further comprising:
determining a point in time, depending on the target torques of the first prime mover (1) and the second prime mover (2), at which the form-locking shift element (9) to be disengaged is theoretically relieved of load or is theoretically approximately relieved of load;
in a defined third interval before the determined point in time, actuating the shift element (9) to be disengaged with the defined actuating pressure or the defined actuating force in the direction of disengagement; and
in response to detecting that the form-locking shift element (9) to be disengaged begins to move within the third interval or at the determined point in time, determining the corresponding actual torques of the first prime mover (1) and the second prime mover (2), and actuating the form-locking shift element (9) to be disengaged by increasing the actuating pressure or the actuating force for complete disengagement.

20. The method as claimed in claim 19, further comprising:
for the case in which the shift element (9) to be disengaged does not begin to move at the defined point in time, equidirectionally increasing and/or reducing the target torque at the first prime mover (1) and the second prime mover (2) with a defined amplitude and frequency in each case for, at most, a defined fourth interval after the determined point in time, and actuating the shift element (9) to be disengaged with the defined actuating pressure or the defined actuating force in the direction of disengagement; and
in response to detecting that the form-locking shift element (9) to be disengaged begins to move within the fourth interval, determining the actual torques of the prime movers (1, 2), and actuating the form-locking shift element (9) to be disengaged by increasing the actuating pressure or the actuating force for complete disengagement.

21. The method as claimed in claim 20, further comprising:
in response to detecting that the form-locking shift element (9) to be disengaged does not begin to move within the fourth interval, terminating the equidirectional increase and/or reduction of the target torques at the first prime mover (1) and the second prime mover (2), and actuating the form-locking shift element (9) to be disengaged by increasing the actuating pressure or the actuating force for complete disengagement.

22. The method as claimed in one of claim 17, wherein the method steps are carried out in a subsequent gearchange in response to determining in a current gearchange while carrying out the method steps that the form-locking shift element (9) to be disengaged does not begin to move during the defined first interval or during the defined second interval.

23. The method as claimed in one of claim 14, wherein the monitoring is carried out directly, with the aid of a position sensor associated with the shift element (9) to be disengaged, to determine whether the form-locking shift element (9) to be disengaged begins to move.

24. The method as claimed in one of claim 14, wherein the monitoring is carried out indirectly, with the aid of one or more of a speed signal of the first prime mover (1), a speed signal of the second prime mover (2), and a speed signal of the driven end (4), to determine whether the form-locking shift element (9) to be disengaged either begins to move or has already disengaged.

25. A control unit for operating a drive train of a motor vehicle, the drive train including a plurality of prime movers (1, 2), a transmission (3), and a driven end (4), and the transmission (3) includes a plurality of shift elements (9), the control unit configured such that:
in order to implement a gearchange from an actual gear into a target gear, the control unit actuates a shift element (9), which is engaged in the actual gear and is disengaged in the target gear, to disengage and actuates a shift element (9), which is disengaged in the actual gear and is engaged in the target gear, to engage;
in order to implement the gearchange, the control unit determines target torques for the first prime mover (1) and the second prime mover (2) at least depending on a driver-demanded output torque;
wherein, when a form-locking shift element (9) is disengaged for the gearchange to be implemented, the control unit relieves the load or approximately relieves the load of the form-locking shift element (9) to be disengaged, via an actuation of the first prime mover (1) and the second prime mover (2) depending on the calculated target torques, in such a way that the target torque is decreased at one of the prime movers and the target torque is increased at another one of the prime movers, in order to disengage the shift element (9) to be disengaged in a load-free or approximately load-free manner while providing the driver-demanded output torque at the driven end (4);
the control unit actuates the form-locking shift element (9) to be disengaged with a defined actuating pressure or a defined actuating force in the direction of disengagement already before a theoretical relief from load or a theoretical approximate relief from load depending on the target torques;
the control unit monitors whether and at which actual torques of the first prime mover (1) and the second prime mover (2) the form-locking shift element (9) to be disengaged begins to move; and
the control unit determines the actual torques of the first prime mover (1) and the second prime mover (2), at which the form-locking shift element (9) to be disengaged begins to move, as actual torques at which the form-locking shift element (9) to be disengaged has actually been relieved of load or has been approximately relieved of load.

26. The control unit as claimed in claim 25, characterized in that the control unit carries out the method of claim 14 on the control side.
